(19) United States
(12) Patent Application Publication
(10) Pub. No.: US 2010/0191544 A1
(43) Pub. Date: Jul. 29, 2010

(54) Protocol Authoring for a Health Coaching Service

(76) Inventors: Adam Bosworth, San Francisco, CA (US); Charles Pearce, San Francisco, CA (US); Stephan Richter, Boston, MA (US); David Rosenthal, San Francisco, CA (US)

Correspondence Address: CARR & FERRELL LLP, 2200 GENG ROAD, PALO ALTO, CA, 94303, US

(21) Appl. No.: 12/360,731

(22) Filed: Jan. 27, 2009

(51) Int. Cl. G06Q 50/00; G06F 3/048

(52) U.S. Cl. 705/3; 705/2; 715/709

(57) ABSTRACT

An author can create a protocol for providing user health coaching. The protocol is based on attributes and configures a health coaching service to be provided for a user. The author can use the attributes to report user health status, set user health goals, and evaluate expressions related to the user's health. The user health status can be reported based on author-created ranges that contain a user health attribute value. User health goals with respect to an attribute can be set over time for a user (or group of users) by the author. Expressions related to the user's health can be created by the author from sets of attributes and operators and executed as rules.

### BACKGROUND OF THE INVENTION

1. Field of the Invention

The present invention generally relates to protocol authoring. The present invention more specifically relates to the authoring of protocols in the context of a health coaching service.

2. Description of the Related Art

Keeping track of personal health is an important part of living a long and productive life. To that end, various services are available to assist people in tracking different aspects of their health.

Existing web services provide calorie information for foods that a user might eat. Such a service allows users to list those foods that the user has consumed; the service then provides a corresponding breakdown of the calories. It is inconvenient in the context of this type of service for a user to track all foods that are eaten throughout the course of a day much less a single meal. Most users, too, do not take the initiative to provide their meal information to the meal tracking service to access calorie information. The usefulness of the meal tracking service is thereby reduced.

Other existing web services provide general health information to a user. These informational services provide articles, discussion forums, and other educational information. These information web services allow users to search for web content that they are interested in and review their retrieved content. For example, one existing web service provides specific information for diabetes.

These existing services do not provide an effective tool for users to track consumed calories on a regular basis. These services require daily and detailed input from a user regarding what the user consumed. Moreover, the services provide only the most generalized health information, which may not be relevant or timely for a user. In some instances, the health information may be counter to the needs of a user with a particular condition and could even be harmful.

One existing web service generates applications for web-based service providers who provide health information. The applications receive user input to determine a group that includes the user. Health information associated with the group is then provided by the application to the user.

This providing of only the most generalized health information is related to the fact that a health provider does not have access to specific user health needs or conditions. A health provider may not be able to obtain specific health needs of conditions from a particular user (absent a face-to-face visit) because the health provider lacks the computer skills or programming savvy to individually implement an on-line interface or community to request such information from the user. Some web services allow a user to submit a question to a practitioner with experience related to the subject matter of the question. The web service will then “post” or otherwise publish the answer to the user's question after some period of time. However, these web services do not consider any personal information about the user when addressing their question, and therefore may only provide broad information that may not be individually tailored to the user. Further, the answer is posted by the web service and is not kept confidential between the user and the practitioner.

There is a need in the art for a health service that provides health information specific to the needs of a particular user. Such a service should offer ease of use not only for the end user but also for the entity providing the health information tailored for the particular user.

### SUMMARY OF THE CLAIMED INVENTION

A protocol for coaching a user can be authored by receiving a selection of a user health attribute at a computing device. Range data can also be received for the user health attribute. The range data can be configured to be reported when a user health attribute value satisfies a range associated with the user health attribute. Expression data can be generated based on the user health attribute. The expression data can be received at the computing device and include one or more operations to perform on the user health attribute. An action selection can be received at the computing device. The action can be performed based on an evaluation of the expression.

A protocol for coaching a user can be authored by receiving a selection of a user health attribute through an interface. The interface can be provided by an application which is executed at a first computing device. Range data can also be received for the user health attribute through the interface. The range data can be configured to be reported when a user health attribute value satisfies a range associated with the user health attribute. Expression data can be received through the interface and include one or more operations to perform on the user health attribute. An action selection can also be received through the interface. The action can be performed based on an evaluation of the expression.

Embodiments of the method can be performed by a computing device in communication with a client or by the client itself. The method can also be performed by a processor executing a program contained on a computer readable storage medium.

### BRIEF DESCRIPTION OF THE DRAWINGS

FIG. 1 is an exemplary system for authoring a protocol.

FIG. 2 is a flowchart of an exemplary method for providing automated coaching.

FIG. 3 is an exemplary interface for setting a range.

FIG. 4 is an exemplary interface for setting calculated attributes.

FIG. 5 is an exemplary interface for setting a goal.

FIG. 6 is an exemplary interface for setting a rule.

FIG. 7 illustrates an exemplary computing system that may be used to implement an embodiment of the present invention.

### DETAILED DESCRIPTION

Embodiments of the present invention allow for the authoring of a protocol for providing user health coaching. The protocol allows the author to configure a number of attributes for the user to report user health status, set user health goals, and evaluate expressions related to user health. The attributes can be received from a user, other source, or calculated based on other attributes. The user health status can be reported based on author-created ranges that correspond to a user health attribute value. User health goals with respect to an attribute can be set over time for a user (or group of users) by the author. Expressions related to the health of a user can be created by the author from sets of attributes and operators and executed based on timing parameters configured by the author.

This attribute based authoring platform allows authors to create a customized health coach protocol without any programming or code generation by the author. Health professionals who might otherwise lack advanced computer programming skills may utilize the platform to provide detailed, in depth, and otherwise important health information to a user in a readily accessible manner. An author can create the protocol by selecting attributes, operators, functions, time periods and other elements from pre-populated lists. An application allows the author to build the protocol by selecting the elements to generate rules, ranges, goals, and expressions. Authors may build a customized, dynamic protocol for monitoring and coaching user health without the time or complexity required with code generation.

The presently disclosed protocol authoring system is flexible in that it considers information from a variety of sources and factors associated with user health. The protocol may incorporate user physical, social, family, and other health related data. The protocol may also process actions that occur once as well as those that occur repeatedly over time based on observed trends. Feedback may be provided to a user based on the most recent user data as well as progress, whether good or bad, made by the user.

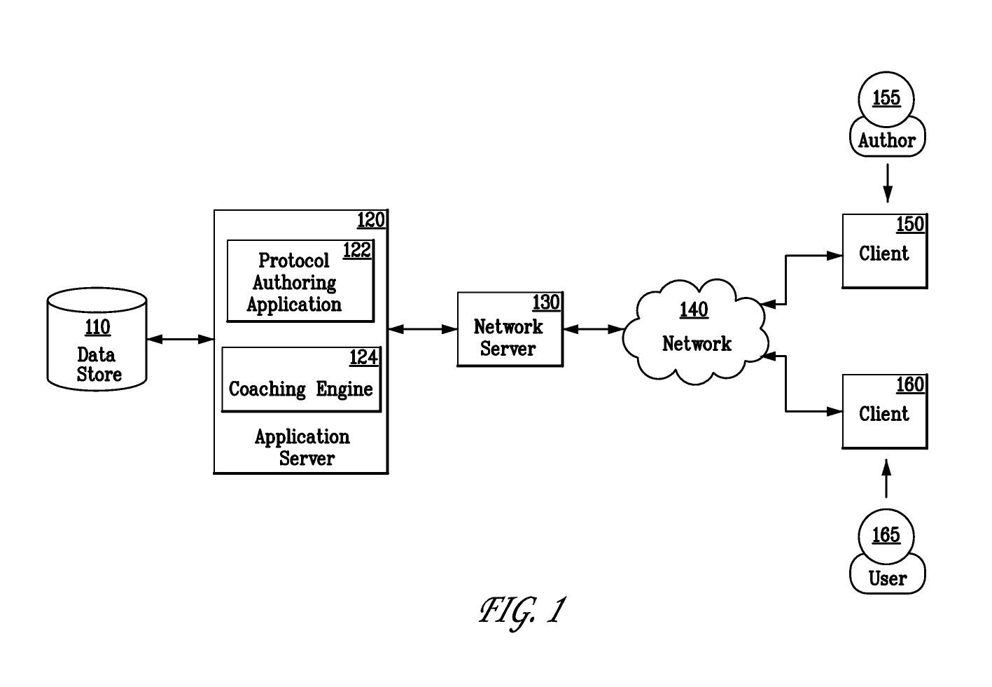

FIG. 1 is an exemplary system for authoring a protocol. The system of FIG. 1 includes data store 110, application server 120, and network server 130.

Data store 110 stores user health data including attribute, range, protocol, goal and other data. Data store 110 can be implemented as a logical data store on the same computing device as coaching engine 124, as one or more separate machines accessible by coaching engine 124, or a combination of the foregoing.

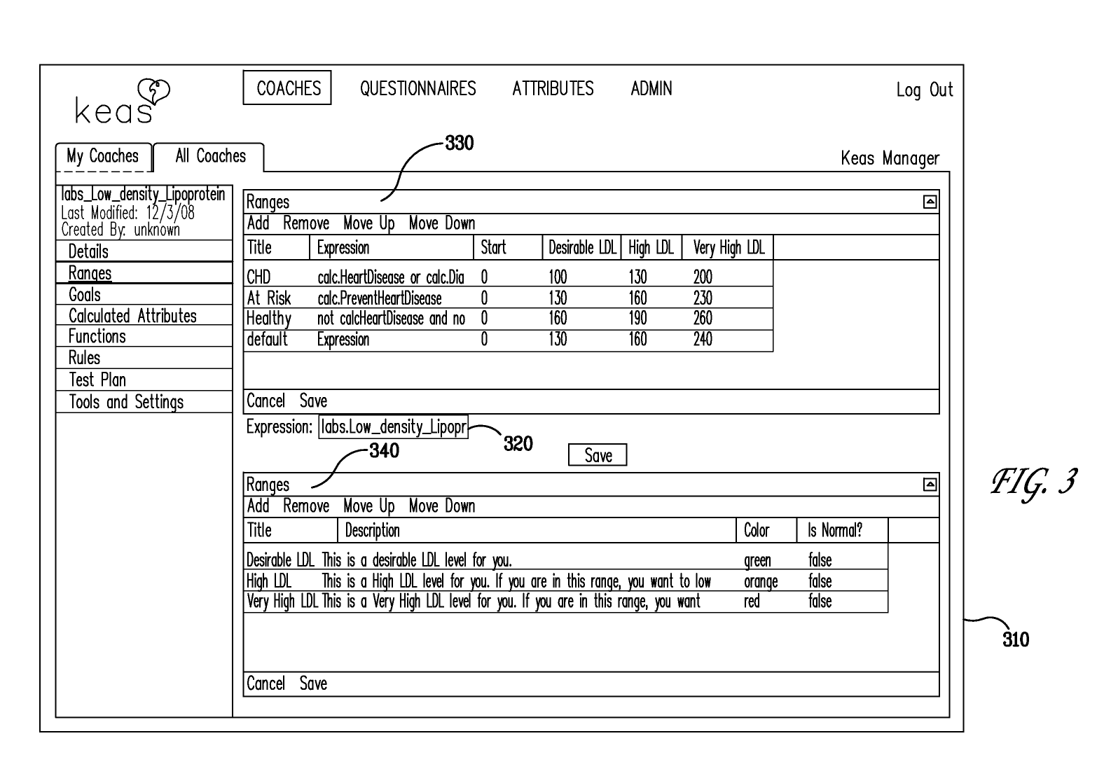

Application server 120 may be implemented in a general computing device that otherwise communicates with data store 110 and network server 130. Application server 120 as illustrated in FIG. 1 includes protocol authoring application 122 and coaching engine 124. Protocol authoring application 122 may by executed by a processor to provide interface data concerning a graphical interface to a client device (e.g., client 150). This interface data may then be executed and rendered as an interface by a client 150 application such as a web browser or Java Virtual Machine. The interface generated from the interface data can be used by author 155 at client 150 for authoring a protocol related to health coaching. The protocol authoring interface as generated from execution of the authoring application 122 can include HTML, XML, scripts, or other code for rendering an authoring interface at client 150 or 160. Exemplary interfaces for authoring a protocol are illustrated in FIGS. 3-6 as discussed in greater detail herein.

Coaching engine 124 is executable by a processor (not shown) at application server 120 to administer a user health coach protocol, where the administration includes generation and management of user attributes, goals, ranges, and rules. Attributes, goals, ranges and rules can be configured in response to input data received from an author 155 at client 150. Client 150, which is inclusive of a general purpose computing device capable of accessing information over a network, can generate the input data based on input received from author 155. Input data may be received at the client 150 through an interface generated from interface data received from execution of the protocol authoring application 122 over network 140.

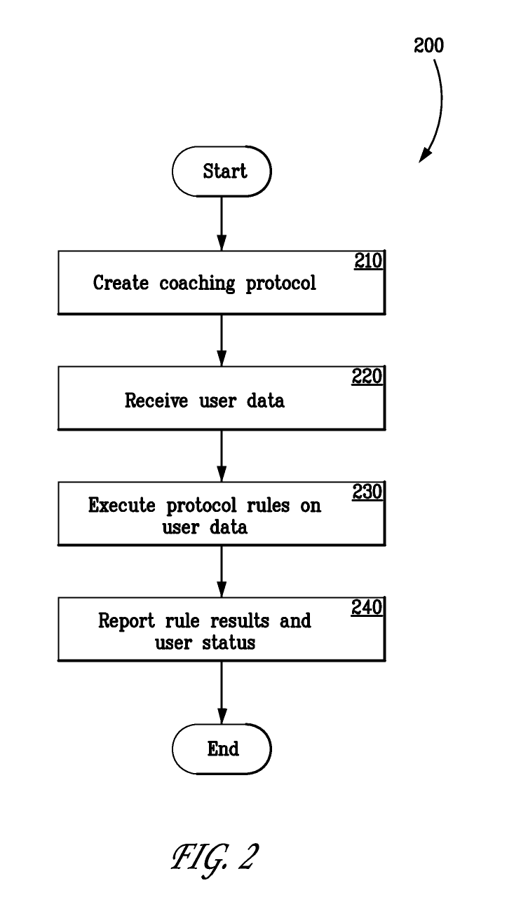

Protocol authoring engine 122 is executed at the application server 120 to access and transmit interface data to client 150 via network server 130 and network 140. The client 150 receives the interface data over network 140 and renders an interface from the interface data in a browser application or other client application, which provides the interface to an author 155. The client 150 may then receive input from an author 155 and transmit input data based on the input to coaching engine 124 on application server 120 or data store 110 over network 140 and network server 130. The input data can include the received input, or data identifying the input, as well as routing information for data packets intended for coaching engine 122. Details of setting attributes, goals, ranges and rules are discussed in more detail below with respect to FIG. 2.

Coaching engine 124 may access user health data from data store 110. The user health data may include user attributes, goals, ranges, rules, and other data associated with the health of a user. The user health data may be retrieved and used to populate one or more interfaces 122. Moreover, data received as input by a client 150 may be transmitted to coaching engine 124 and stored in data store 110.

Coaching engine 124 can process the goals, attributes and rules to provide alerts, suggestions, updated goals, status and calculated attributes, and other content for a user 165. The content can be provided to a user through a coaching interface provided through client 160. For example, user 165 at client 160 may perform a login with a service provided by coaching engine 124 and receive interface data as a browser application content page. The interface data may include any updates for the user health status, including updated user goals, attribute values, and results of executed rule expressions.

Network 140 is inclusive of any communication network such as the Internet, Wide Area Network (WAN), Local Area Network (LAN), intranet, extranet, private network, or other network. Application server 120 may be accessed via network server 130. Network server 130 can receive and process requests from clients 150-160. Processing the requests may include sending a request to coaching engine 124 on application server 120, receiving a response from coaching engine 124, or forwarding that response to a requesting client.

Clients 150 and 160 may be implemented as computing devices such as workstations, servers, lap top computers, mobile devices, or other computing devices that can communicate over network 140. Client 150 may include a browser application for rendering coach protocol authoring interface data as a web page interface. Client 160 may include a browser application for rendering coach interface data as web pages interfaces for accessing user health updates and content.

FIG. 2 is a flowchart of an exemplary method 200 for providing automated coaching. First, a coaching protocol is created at step 210. The protocol can be generated based on author input received through one or more interfaces derived or rendered from protocol authoring interfaces rendered at client 150. Protocol authoring application 124 transmits interface data to be rendered as an interface at client 150. An author 155 provides input to client 150 through the rendered interface and the client 150 transmits input data to coaching engine 124 via network 140 and network server 130. Creating the protocol can include setting ranges, user attributes, user goals and user rules.

Creating a coaching protocol begins with setting user ranges. Ranges can be set by a protocol author for one or more user attribute values. An author can specify one or more ranges for each attribute. The range data associated with a range can include a range value, a range label, and other data. When user data is received by a coaching engine (step 220 of the method of FIG. 2), a portion of the reported user status (step 240 of the method of FIG. 2) includes the ranges associated with the user attribute values.

When setting a user range, an attribute selection is received. The selected attribute can include a simple attribute or a calculated attribute. Range values are also received. One or more range values can be set for each user or user group for the attribute. A range label, in turn, can have a title and description, and each range can be associated with a range label.

In some embodiments, an attribute may have three ranges corresponding to a desirable range, undesirable range, and very undesirable range. It should be noted that certain attributes may have more or less than three ranges. In the present example, a user attribute of “weight” may have ranges of less than 190, 190-220 and over 220, corresponding to range labels of “desirable weight,” “overweight,” and “obese,” respectively. The three ranges can also be associated with an indicator that communicates the level of desirability of the range. For example, the desirable weight range may be associated with a green colored indicator (indicating that a weight value within this range is highly desirable), the overweight weight range may be associated with a yellow colored indicator (indicating a less than weight attribute value is less than desirable), and obese weight range may be associated with a red colored indicator (indicating that a weight value within this range is highly undesirable). The indicators, range labels and other data can be provided to a user as part of a user status report.

The received range data may comprise input provided by an author to client 150. Client 150 may then transmit input data based on the received input to coaching engine 124 on application server 120 via network 140 and network server 130. After receiving the range data, coaching engine 124 may store the range data locally or to data store 110.

User attributes can include simple attributes and calculated attributes. Simple attributes can be provided by a user or some other source and stored as they are received. Calculated attributes can be derived from the simple attributes and/or other data. The calculated attributes can further be predefined or can be defined by an author. Both simple and calculated attributes can be used by an author to generate user goals and rules, as well as to define one or more ranges.

Simple attributes can be received through user questionnaires or other user input, medical facilities, laboratories, or some other source of user health data. Simple attributes can include general attributes, past medical history, family history, vaccinations, social history, procedures, allergies, and labs and medication attributes. General attributes can include height, weight, demographic data, blood pressure, and other general information for a user. Past medical history can include conditions such as strokes and/or other past medical history for a user. Family history can include data regarding disease, conditions, and health patterns of user family members. Vaccination attributes can indicate any vaccinations a user has or has not received. Social history attributes include whether a user smokes, drinks alcohol, uses recreational drugs, or other social related attribute data. Procedures data may include past surgeries and other interventions such as colonoscopy and colposcopy. Allergies data may indicate allergies the user is known to have. Labs and medication data can include data from lab tests, current medications taken by the user, past medications taken, allergies, and other data.

A calculated attribute can be specified for one or more users by an author based on an expression generated by the author. The expression can be created through a calculated attribute generation interface rendered from a coach protocol authoring interface 122. An author may create the expression by selecting simple attributes, existing calculated attributes, and operations to perform on the selected attributes. The attributes and operations can be selected from lists that are populated with existing attributes and operations, thereby allowing a user to easily create new calculated attributes without generating new code. Attribute input received from an author by client 150 can be transmitted by the client to coaching engine 124 which can store the range data locally or remotely to data store 110.

A user goal can be set for any number of user attributes. The goals can specify an attribute, variable, or state, a time, a description, timeline and/or other data relating to the goal. Goals may involve one requirement or several requirements over time.

A goal attribute is the attribute for which the goal will be set for. A goal target is the threshold used to determine whether the goal has been successfully achieved. For example, a goal for a body mass index (BMI) attribute may have a value of 24.9. Goal timeline data allows for a number of goals over a period of time for a particular user attribute. By setting a timeline, a goal can be divided into a number of “time slices” with a set of progressive goals for the user to achieve over time. Goal input received from an author by client 150 can be transmitted by the client to coaching engine 124, which can store the range data locally or remotely to data store 110.

With respect to setting user rules, a rule can include an expression for evaluation, an action to be taken based on the evaluation outcome, and timing data (or periodicity data) indicating when the rule should be evaluated. The rule can also include a description and a rule name. Execution of a rule can result in an action to take with respect to one or more users.

One or more attributes and operations are received as part of a rule expression. The attributes can be selected by a user from a drop down menu of simple and calculated attributes, such as height, weight, sex, BMI, LDL, blood pressure, and so forth. The operation can indicate an expression to perform on the attribute, such as calculate a value for, determine if the attribute has a value of true or false, determine if the attribute value is greater than or less than some value or other attribute, or some other operator. Thus, an author can generate an expression comprised of an attribute and an operation performed on the attribute to determine if a particular condition regarding the attribute exists.

A trend function is a type of operation that evaluates the trend of an attribute value over time. For example, a trend function can determine if a particular attribute value has increased over time, has surpassed a particular value a certain number of times over a time period, whether the attribute value experienced a particular rate of increase decrease over time, or some other attribute trend.

A rule action can be performed based on the result of the evaluation of the rule expression. An author can configure a rule action as notification, instructions to exercise, diet, take lab test, see a particular health care provider, enroll in a program, fill out a questionnaire, improve a value, or some other action. For example, an author can configure an action as a user notification that a lab result has been received from a laboratory, that a particular user attribute has a value which is undesirable, or some other event. A rule action can be tagged with content, such as a blog, pod cast, video, audio, image, or some other data. Based on execution of the rule, the content can be forwarded to the user as part of an action if the conditions for the rule have been met.

Rule periodicity information indicates how often the rule should be evaluated. For example, the rule can be evaluated once at user's initial log in to his or her account, once a month, annually, upon receiving a particular update to a particular attribute, receiving a particular lab data, or based on some other event. Storing a rule may include receiving rule data from client 150. The rule data can be derived from input received by client 150 through a browser application or other application providing a protocol authoring interface. Coaching engine 124 can store the rule data locally or remotely to data store 110.

Protocol data may eventually be received by coaching engine 124 from client 150. Client 150 may provide one or more interfaces rendered by a browser application or some other application. The interfaces may provide range, attribute, goal and rule information as illustrated in FIGS. 3-6. An author may provide range, attribute, goal and rule input to client 150. Client 150 may then transmit input data based on the received input to coaching engine 124 on application server 120 via network 140 and network server 130. After receiving the range data, coaching engine 124 may store the range data locally or to data store 110.

Returning to the method of FIG. 2, after creating the coaching protocol, user data can be received at step 220. The received data can include user attributes, past medical history, family history, vaccinations, social history, procedures, allergies, lab data, and other data. The user data can be received through user questionnaires provided by the health coach service, data provided from medical facilities, lab test results or other sources.

After receiving user data, protocol rules can be executed on the user data according to the coaching protocol at step 230. The protocol rules are executed by coaching engine 124 according to the authored protocol. After executing protocol rules, rule results are reported and a user status is updated at step 240. Reporting results and user status can be performed in response to execution of the rules at step 230. The results and status can be reported as an alert, via e-mail, posting within a content page provided by the health coach service, or in some other manner.

FIG. 3 illustrates an embodiment of an interface 310 for setting a range. The interface of FIG. 3 can be derived from protocol authoring interface data and rendered in a browser application residing on client 150. In the interface of FIG. 3, the selected attribute 320 is “labs.Low_density_lipoprotein” or LDL. Values for the attribute LDL can receive from a medical facility in the form of a lab result.

A first portion 330 of the interface allows an author to specify a title for a set of ranges, the expression for which a value will be placed within a range, and the range values. For example, the second row in the first portion 330 indicates that ranges for the expression “calc.PreventHeartDisease” will have a title of “At Risk” and have range values of 0-130, above 130 to 160, and above 160 to 230. The three ranges have titles of “Desirable LDL,” “High LDL,” and “Very High LDL.”

A second portion 340 of the interface 310 allows an author to specify label information of title, description, color (an example of a visual indicator) and other data for the ranges. For example, the range title of “Desirable LDL” has a description of “This is a desirable LDL level for you,” a color of “green,” and other information data indicating that the desirable LDL is not normal (e.g., a value of “false” in the column of “Is Normal?”)

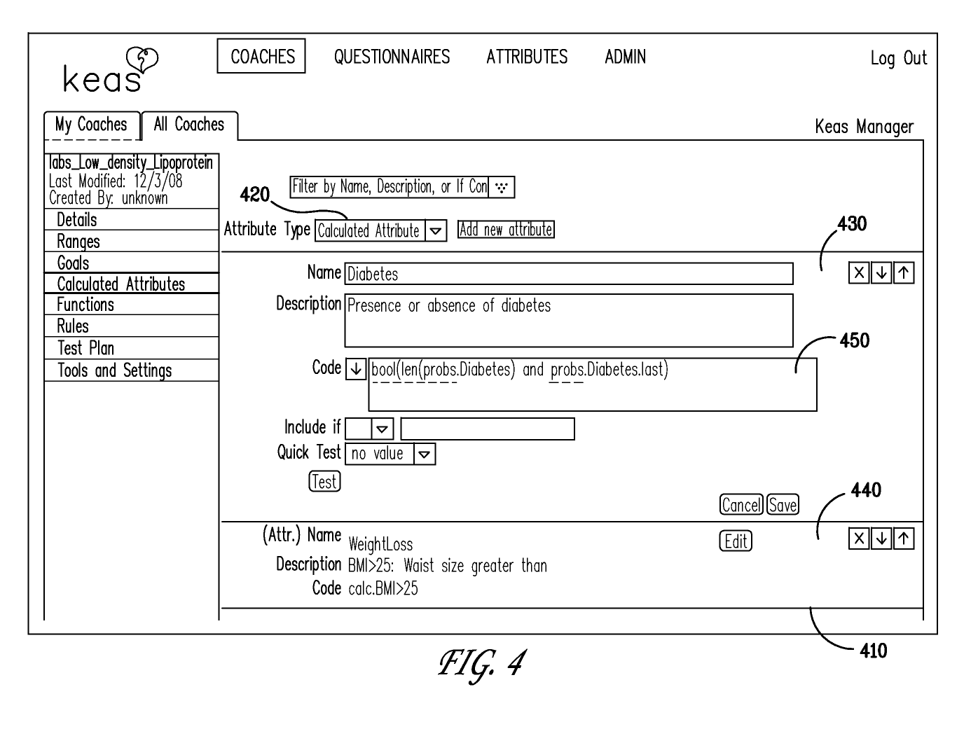

An example of an interface 410 that allows an author 150 to create a calculated attribute is illustrated in FIG. 4. A list of categories is displayed in left side of the interface, of which “calculated attributes” is currently selected. An attribute type of “calculated attributes” is selected in attribute type box 420. As a result, a list of calculated attributes is listed within the interface, including data for a first calculated attribute 430 and a second calculated attribute 440. Data for the second calculated attribute 440 “WeightLoss” includes summary information for the attribute as well as an icon for selecting to “edit” the calculate attribute. Information for the first calculated attribute 430 “Diabetes” includes detailed information provided as a result of an “edit” button for the first calculated attribute being selected.

The first calculated attribute 430 in interface 410 has a name “Diabetes,” a description of “Presence of absence of diabetes,” and an expression box 450. The expression box 450 contains the expression which is evaluated to determine the calculated attribute value. The expression is built using lists of attributes and operations available to the coaching engine (for example, the lists may be populated from libraries of attributes and operations stored in data store 110). The expression in expression box 450 is “bool(len(probs.Diabetes) and probs.Diabetes.last).” The expression indicates that the calculated attribute “Diabetes” has a Boolean value derived from the length of the object “probs.Diabetes” and the object “probs.Diabetes.last.”

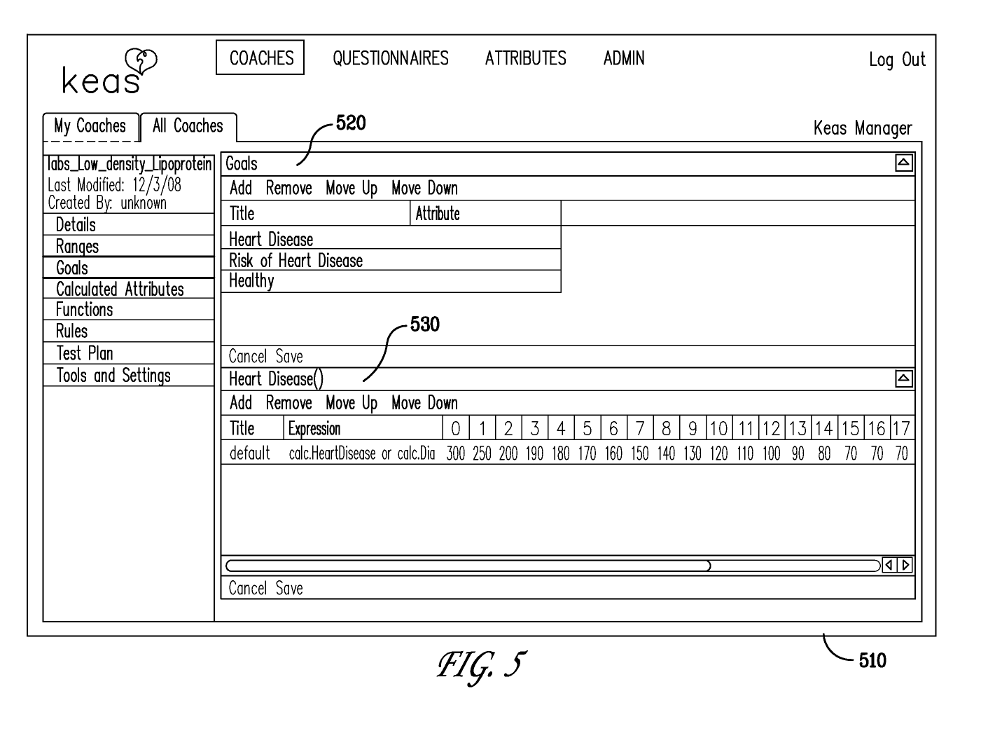

An example of an interface 510 that allows an author 150 to create a user goal is illustrated in FIG. 5. The interface 510 includes a first portion 520 for selecting a particular goal attribute and a second portion 530 for configuring the selected goal. In the first portion 520, the goal attribute “Heart Disease” is selected from the listed attributes of “Heart Disease,” “Risk of Heart Disease” and “Healthy.” In the second portion 530 of interface 510, the “heart disease” goal attribute is listed along with the attribute expression (i.e., the attribute is a calculated attribute), the goal timeline and goal target for each time slice of the timeline. A goal timeline is indicated as monthly for the next seventeen months. A particular goal target is set or each of the seventeen months. For example, the goal targets for the first five months are 300, 250, 200, 190, 180 and 170. The goal timeline and targets allow an author to create a series of goal steps to achieve an ultimate goal over the period of time.

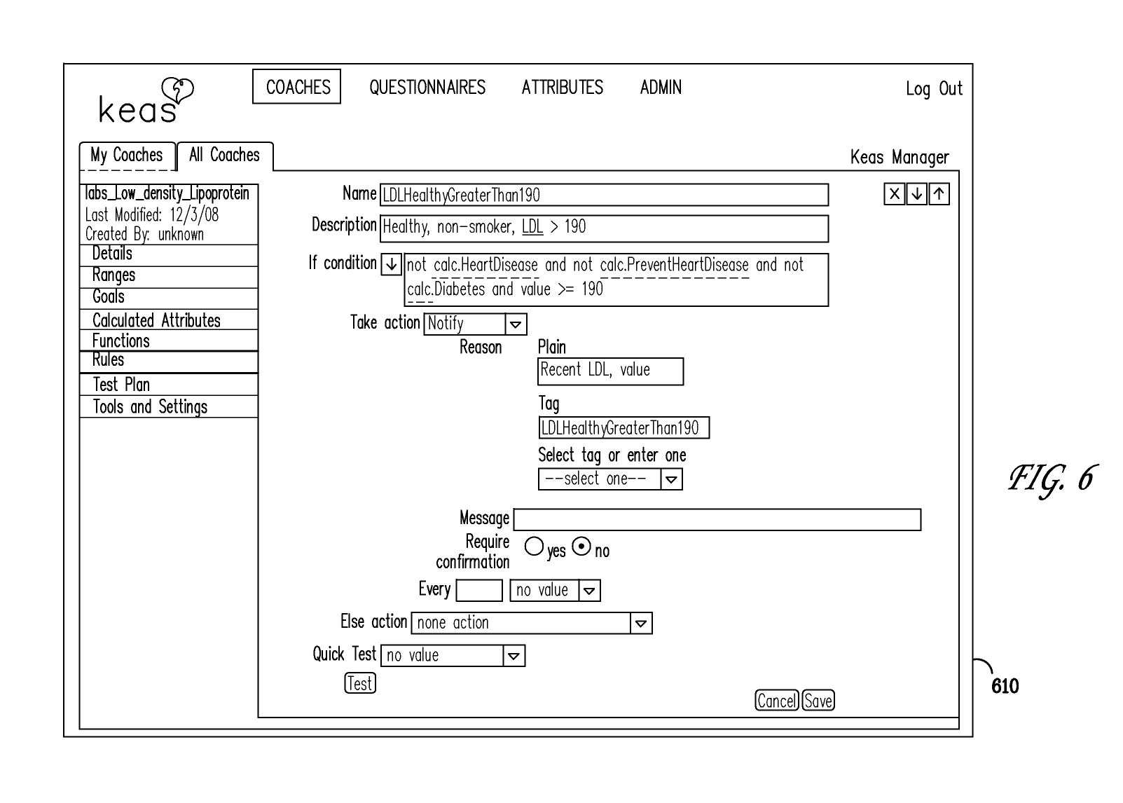

An example of an interface 610 that allows an author 150 to create a rule is illustrated in FIG. 6. The interface includes input boxes for an author to provide a rule name, description, expression, action, periodicity and other data. The rule name is provided as “LDLHealthyGreaterThan190,” the rule description is entered as “Healthy, Non-smoker, LDL>190,” and the rule expression is entered as “not calc.HeartDisease and not PreventHeartDisease and not calc.Diabetes and value.LDL>=190.” In the expression, the “HeartDisease,” “PreventHeartDisease,” and “Diabetes” terms identify attributes, the “calc” term indicates that values of the appropriate attribute should be calculated, the “not” term indicates that the value should not have a value of “TRUE,” and the “value” and “>=190” indicate that the value of the appropriate attribute should have a value greater than or equal to 190.

The selected rule action is performed if the rule is expression is evaluated to be true. The rule may be comprised of an action and, in some instances, content to provide with an action. The content may be identified by a “tag” associated with the content. In the rule configured in the interface, if the “HeartDisease,” “PreventHeartDisease,” and “Diabetes” attributes are true and the “LDL” attribute has a value greater than or equal to 190, the rule will notify the user with content associated the tag “LDLHealthyGreaterThan190.” The selected rule may have periodicity information associated with it that specifies how often the rule is evaluated. The periodicity information indicates that the rule expression should be evaluated one time every month.

Each rule may be configured with additional data, such as quick test data for testing evaluation of the expression and whether a confirmation should be received from a user that a notification or other action has been performed. The quick test data configuration can identify a file of data which provides values for the expression. An author 150 can have the expression evaluated by selecting the “test” button after a test file of data is identified. The coaching engine 124 will evaluate the expression using the quick test data and provide the results to an author 150 in a separate interface. A confirmation requirement tracks whether a user has provided confirmation as to whether a notification was read, a health provider appointment was made, or some other action was completed.

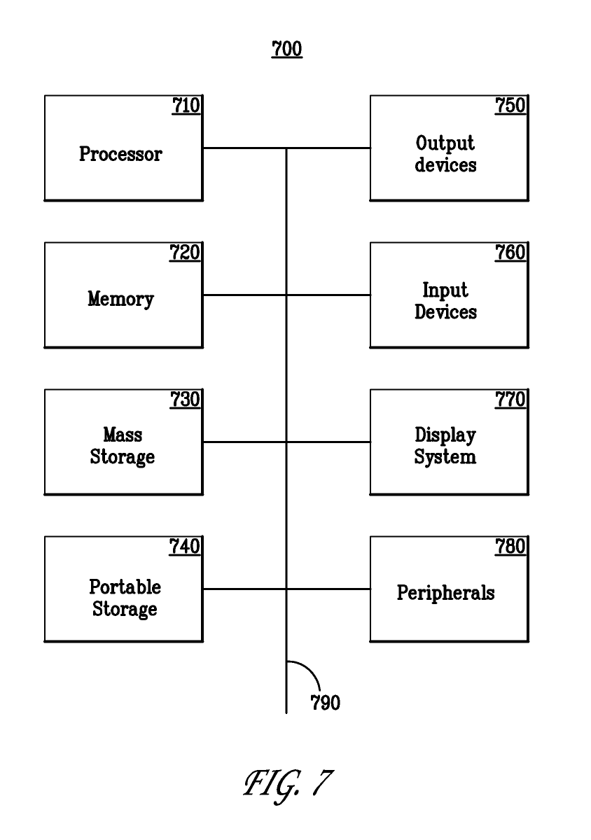

FIG. 7 illustrates an exemplary computing system 700 that may be used to implement an embodiment of the present invention. System 700 of FIG. 7 may be implemented in the contexts of the likes of data store 110, application server 120, network server 130, database 122, and clients 150-160. The computing system 700 of FIG. 7 includes one or more processors 710 and memory 710. Main memory 710 stores, in part, instructions and data for execution by processor 710. Main memory 710 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 710 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for authoring a protocol to coach a user, comprising:
receiving a selection of a first user health attribute at a computing device;
receiving range data for the first user health attribute at the computing device, the range data configured to be reported when the value of the first user health attribute satisfies a first range associated with the user health attribute;
generating expression data based on the first user health attribute, the expression data received at the computing device and including one or more operations to perform on the first user health attribute; and
receiving a selection of an action at the computing device, the action performed based on a result of an evaluation of the expression.

2. The method of claim 1, wherein the user health attribute is a calculated attribute derived from one or more simple user health attributes.

3. The method of claim 1, wherein the range data includes a range of values and a range label.

4. The method of claim 3, wherein the range data includes a plurality of range values and a plurality of range labels corresponding to a plurality of ranges.

5. The method of claim 1, wherein the step of generating the expression data includes:
receiving a selection for the first user health attribute from a set of user health attributes; and
receiving a selection for a first operator from a set of operators;

6. The method of claim 1, wherein generating the expression includes receiving a selection from an author for a most recent value for the first user health attribute.

7. The method of claim 1, wherein generating the expression includes receiving a selection from an author for a trend over time for the first user health attribute.

8. The method of claim 1, wherein receiving a selection of an action includes tagging the action with content, the content provided to a user as part of performing the action.

9. The method of claim 1, further comprising receiving a selection of timing data from an author, the timing data identifying when the expression is evaluated.

10. The method of claim 1, further comprising receiving progressive goal data over a period of time for the first user health attribute.

11. The method of claim 10, further comprising:
identifying a set of users which satisfy one or more health attribute requirements selected by an author; and
setting a set of progressive goals for the set of users.

12. The method of claim 1, wherein the selected first user health attribute, the expression data and the selected action are received from a protocol author, the action configured to be performed with respect to a user of a service controlled by the protocol.

13. A method for authoring a protocol to coach a user, comprising:
receiving a selection of a first user health attribute through an interface provided by an application executed at a first computing device;
receiving range data for the first user health attribute through the interface, the range data configured to be reported when the value of the first user health attribute satisfies a first range associated with the user health attribute;
receiving expression data for on the first user health attribute through the interface, the expression data including one or more operations to perform on the first user health attribute; and
receiving a selection of an action through the interface, the action performed based on a result of an evaluation of the expression.

14. The method of claim 13, further comprising transmitting the first user health attribute, range data, expression data, and action as part of a protocol to be controlled by a server in communication with the first computing device.

15. The method of claim 13, wherein the user health attribute is a calculated attribute derived from one or more simple user health attributes.

16. The method of claim 13, wherein the range data includes a range of values and a range label.

17. The method of claim 13, wherein generating the expression data includes:
receiving a selection for the first user health attribute from a set of user health attributes; and
receiving a selection for a first operator from a set of operators;

18. The method of claim 13, wherein generating the expression includes receiving a selection from an author for a trend over time for the first user health attribute.

19. The method of claim 13, further comprising receiving a selection of timing data from an author, the timing data identifying when the expression is evaluated.

20. The method of claim 13, further comprising receiving progressive goal data over a period of time for the first user health attribute.

21. A computer readable storage medium having embodied thereon a program, the program being executable by a processor to perform a method for authoring a protocol to coach a user, the method comprising:
receiving a selection of a first user health attribute;
receiving range data for the first user health attribute, the range data configured to be reported when the value of the first user health attribute satisfies a first range associated with the user health attribute;
generating expression data based on the first user health attribute, the expression data including one or more operations to perform on the first user health attribute; and
receiving a selection of an action, the action performed based on a result of an evaluation of the expression.

22. The computer readable storage medium of claim 21, wherein the user health attribute is a calculated attribute derived from one or more simple user health attributes.

23. The computer readable storage medium of claim 21, wherein the range data includes a range of values and a range label.

24. The computer readable storage medium of claim 21, wherein generating the expression includes receiving a selection for a most recent value for the first user health attribute.

25. The computer readable storage medium of claim 21, wherein generating the expression includes receiving a selection for a trend over time for the first user health attribute.

26. The computer readable storage medium of claim 21, further comprising receiving a selection of timing data from an author, the timing data identifying when the expression is evaluated.

27. The computer readable storage medium of claim 21, further comprising receiving progressive goal data over a period of time for the first user health attribute.

28. The computer readable storage medium of claim 21, further comprising:
identifying a set of users which satisfy one or more health attribute requirements selected by an author; and
setting progressive goals for the set of users.

29. The computer readable storage medium of claim 21, wherein the selected first user health attribute, the expression data and the selected action are received from a protocol author, the action configured to be performed with respect to a user of a service controlled by the protocol.
